(19) United States
(12) Patent Application Publication
(10) Pub. No.: US 2012/0036155 A1
(43) Pub. Date: Feb. 9, 2012

(54) ON-LINE SEARCHING SYSTEMS

(75) Inventors: Robert Jan Aarts, Espoo (FI); Juha Pekka Tapani Koponen, Helsinki (FI); Jussi Viljami Koskinen, Espoo (FI)

(73) Assignee: NETCYCLER OY, Espoo (FI)

(21) Appl. No.: 13/262,667

(22) PCT Filed: Apr. 3, 2009
(86) PCT No.: PCT/EP2009/054054

§ 371 Date: Oct. 3, 2011

(51) Int. Cl. G06F 17/30

(52) U.S. Cl. 707/770; 707/E17.014

(57) ABSTRACT

A method of identifying within a database of node pairs, one or more complete paths connecting a start search node to a finish search node. The method includes sending a search query from a client terminal to a network: receiving the search query at a server, identifying node pairs having a finish node matching a start search node, sending a response from the server to the client terminal identifying any matching node pairs, and storing responses of any matching node pairs that have as a start node the finish search node. Further search queries are distributed across all servers, and node pairs having a finish node matching the start node contained in the query are identified. A response is sent from the server to the client terminal identifying any matching node pairs

### TECHNICAL FIELD

The present invention relates to on-line searching systems and is more particularly, but not exclusively, concerned with on-line trading systems that allow the general public to sell or exchange personal items and services.

### BACKGROUND

A number of websites have appeared in recent years to facilitate the exchange or bartering of items and services between members of the public. An example is the Swaptree™ site available at www.swaptree.com. In a two-way barter, two people directly swap their items or services. The problem of course with two-way barter is that, particularly for unusual items, it may be difficult for a first party to link up with another party who has exactly what the first party is looking for. The probability of finding a barter partner grows dramatically in large user bases when a multi-partner barter is allowed, that is when a ring or chain of trades is allowed.

In an n-way barter, a group of people exchange their “Offers” and “Wishes”. Consider that a person P1 has an item that can be specified by A and wishes to trade it for an item that satisfies D. If we prefix a person with the item that they have offered for sale (Offer) and postfix that person with the specification of the item that they want (Wish) we could write the exchange required by that person as A-P1-D. Assuming that there also are the following three persons with their own “Offers” and “Wishes”: D-P2-C, C-P3-B, B-P4-A, then these four people could form a closed exchange ring where P1 gives item A to P4, P4 then gives item B to P3, P3 gives item C to P2 and finally P2 gives item D to P1. The problem now is finding such closed exchange rings in a very large set of items, each associated with one or more offer/wish specifications. This problem is a form of path finding problem.

On-line barter systems are considered in the following publications; U.S. Pat. No. 6,847,938, KR20010025282, WO2006034221, WO0124091, WO2004027660, US2003088497, JP2003076881, JP2002318936, JP2002269385, WO0139081, WO2008057255, WO2008057276, WO2008057277, US2007244769, US2007244770, US2007244772,

US2007244793, US20070244801, US20070255624, WO2007121298, and WO2007121305. In addition, barter sites share many characteristics with on-line auction and sales sites such as ebay™ and Wigix™. However, the former are necessarily more complex in that a search of the listings must identify both “Offers” and “Wishes”, and not just “Offers” as in the case of the auction sites. Moreover, a search on a barter site should identify all possible n-way barters (or at least up to some defined path length).

Especially in the case of a large user base, it is desirable to automate as much as possible the searching process in a barter system, rather than leaving it to the user to “manually” browse through categories and items. Automated searching relies heavily upon the accurate and detailed categorisation of offered items and services and may be carried out “on-demand”, i.e. in response to a user entering a “Offer” and a “Wish” into the system, or by way of periodic “clearing” in which user requests are queued and subsequently cleared in a single pass through the system.

Conventional automated searching systems accept a user generated query containing an offer and a wish at a server. The server then searches a database in an attempt to identify one or more barter chains that will satisfy the user (and of course the other users in those chains). Whilst strategies to optimise the search process can be devised, this task remains very computationally intensive for a large user base, and leaves the server extremely vulnerable to high surges in demand. Queries can of course be distributed across a set of servers forming a server “farm”, but such an architecture is both expensive and difficult to maintain.

### SUMMARY

Recently, so called “web-server clouds” have become available. The Google™ App Engine (http://appengine.google.com/google/) is one such computing cloud that can be “rented” for third party use, but other examples exist. A web server cloud may comprise a large number of web servers, for example on the order of 100,000, which are responsible for providing actual web content to users. Behind these web servers sit database servers that maintain user data. In the case of the Google App Engine, the database server arrangement is known as the BigTable, with data being distributed across the database servers in some optimal way.

Obviously, it is extremely desirable to take advantage of a web-server cloud in order to provide a bartering service or other service requiring computationally expensive database searches. However, cloud operators can place a limit on the time that is allowed to perform an individual query within the cloud. This could be of the order of one second. This would effectively preclude the use of a web-server for computationally intensive tasks such as those associated with a barter service, at least when a conventional search strategy is employed.

It is an object of the present invention to provide a solution to the above described problems that is capable of quickly and efficiently identifying n-way trades whilst making use of web-server clouds. The solution may also be useful in other on-line searching systems.

According to a first aspect of the present invention there is provided a method of identifying within a database of node pairs, each comprising a start node and a finish node, one or more complete paths connecting a start search node to a finish search node. The method comprises:
a) sending a search query containing at least said start search node, from a client terminal to a network containing a multiplicity of servers each having access to said database;
b) receiving the search query at one of said servers, identifying node pairs having a finish node matching said start search node, and sending a response from the server to the client terminal identifying any matching node pairs;
c) receiving the response at the client terminal and storing those of any matching node pairs that have as a start node said finish search node;
d) in respect of each of one or more node pairs that have as a start node said finish search node, sending a further search query containing at least the corresponding start node to said network;
e) receiving the search queries within said network and distributing them across ones of the multiplicity of servers;
f) at each server receiving a further search query, identifying node pairs having a finish node matching the start node contained in the query, and sending a response from the server to the client terminal identifying any matching node pairs;
g) receiving the responses at the client terminal and storing those of any matching node pairs that have as a start node said finish search node; and
h) iteratively repeating steps d) to g) in respect of the further responses until some predefined criterion is met.

Embodiments of the present invention provide a searching solution that effectively splits a larger search into a large number of smaller searches. Whilst placing an increased computational burden on the client terminal, which is nonetheless easily manageable by that terminal, the solution both paralellises the search with a server cloud and overcomes any computational restrictions placed on the handling of queries by the server cloud.

The method may comprise, at steps a) and d), including in said search queries said finish search node and, at steps b) and f), identifying at the servers any of said matching node pairs that have a start node matching said finish search node and specifying these node pairs in said response.

The method may comprise, at steps c) and g), following receipt of said responses at the user terminal, identifying at the client terminal any of said matching node pairs that have a start node matching said finish search node.

In an embodiment of the invention, steps a), c), d) and g) are implemented via a web browser running on the client terminal, with said responses being sent from the servers to the client terminal are sent as web page data. At steps c) and g), the step of storing comprises causing the matching node pairs that have as a start node said finish search node to be displayed on the client terminal.

The method may comprise, at step d), including in each said further search query the corresponding path including said start search node and the start and finish nodes of the already identified node pairs in the path. Similarly, at step f), the method comprises including in each said response the corresponding path including said start search node and the start and finish nodes of the already identified node pairs in the path, including the node pair just identified. The method then comprises causing the matching node pairs that have as a start node said finish search node to be displayed on the client terminal within the corresponding complete path.

The predefined criterion is one of a predefined number of iterations or a predefined number of complete paths.

The method may comprise, for each iteration stage, sending each of the further search queries asynchronously, with a further search query being sent without waiting for a response to any earlier sent search query of the iteration stage.

Where said database is a database associated with an online trading service, and each said node pair is associated with a trading user, the method may comprise,
for each node pair, the start node is one of an item/service possessed or wanted by the associated user and the finish node is the other of the item/service possessed or wanted, and
said start search node is one of an item/service possessed or wanted by a user of said client terminal and the finish search item is the other of an item/service possessed or wanted by that user.

According to a second aspect of the present invention there is provided a method of identifying complete paths, from a start search node to a finish search node, and extending across one or more node pairs each defined by a start node and a finish node. The method comprises:
a) sending a search query containing said start and finish search nodes from a client terminal to a network containing a multiplicity of servers each having access to said database;
b) receiving the query at one of said servers and identifying node pairs having a finish node matching said start search node, and, for each identified node pair, associating the node pair with said start search node to construct a search path, identifying any of said search paths that represent a complete path, and returning both complete and incomplete paths to the client terminal;
c) receiving complete and incomplete paths at the client terminal, storing any complete paths and, for each incomplete path, sending a further search query containing the incomplete search path and said finish search node to said network;
d) receiving the further search requests at servers of the network and, at each server receiving a query, identifying node pairs having a finish node matching the start node of the last node pair in the corresponding incomplete search path, and, for each identified node pair, associating the node pair with the incomplete path to form an extended search path;
e) at the receiving servers, identifying any of said extended search paths that represent a complete path, and returning both complete and incomplete paths to the client terminal;
f) repeating steps c) to e) in respect of the further responses until some predefined criterion is met.

According to a third aspect of the present invention there is provided a method of identifying within a database of node pairs, each comprising a start node and a finish node, one or more paths connecting a start search node to respective finish search nodes. The method comprises:
a) sending a search query containing at least said start search node, from a client terminal to a network containing a multiplicity of servers each having access to said database;
b) receiving the search query at one of said servers, identifying node pairs having a finish node matching said start search node, and sending a response from the server to the client terminal identifying any matching node pairs;
c) receiving the response at the client terminal and storing at least the start node of each matching node pair;
d) in respect of each of the matching node pairs, sending a further search query containing at least the corresponding start node to said network;
e) receiving the search queries within said network and distributing them across ones of the multiplicity of servers;
f) at each server receiving a further search query, identifying node pairs having a finish node matching the start node contained in the query, and sending a response from the server to the client terminal identifying any matching node pairs;
g) receiving the responses at the client terminal and storing at least the start node of each matching node pair; and
h) iteratively repeating steps d) to g) in respect of the further responses until some predefined criterion is met.

For each matching node pair identified at a server, a weight associated with a link connecting that node pair to the preceding node in the path may be determined, and a sum of the weights of all node pairs in the path determined and stored at the client terminal. This weight may be indicative of an amount of carbon dioxide that would be generated by a business transaction involving the associated node pairs.

According to a fourth aspect of the present invention there is provided computer program configured to be run in association with a web browser on a computer to cause the computer to:
1) parse web data, received in response to a search request sent from the computer to the Internet, so as to identify incomplete results in the web data;
2) send to the Internet, for each identified incomplete result, a further search request, these requests being sent asynchronously; and
3) to repeat steps 1) and 2) for each further response.

The computer program may be a Javacode program, an applet, browser plugin, or the like.

### BRIEF DESCRIPTION OF THE DRAWINGS

FIG. 1 illustrates in simplified schematic form a network for supporting an on-line barter service;

FIG. 2 illustrates schematically a user terminal of the network of FIG. 1; and

FIG. 3 is a flow diagram showing a search procedure associated with a user initiated barter query.

### DETAILED DESCRIPTION OF AN EMBODIMENT

An online barter system will now be described which employs a set or “cloud” of web-based servers to distribute the computational load associated with answering a given barter search request generated by a user. The exact architecture of the cloud can vary, but a key feature of it is that it is able to perform large numbers of queries in parallel. The time allowed by the server cloud for receiving and responding to an individual query can be relatively short, e.g. one second or less.

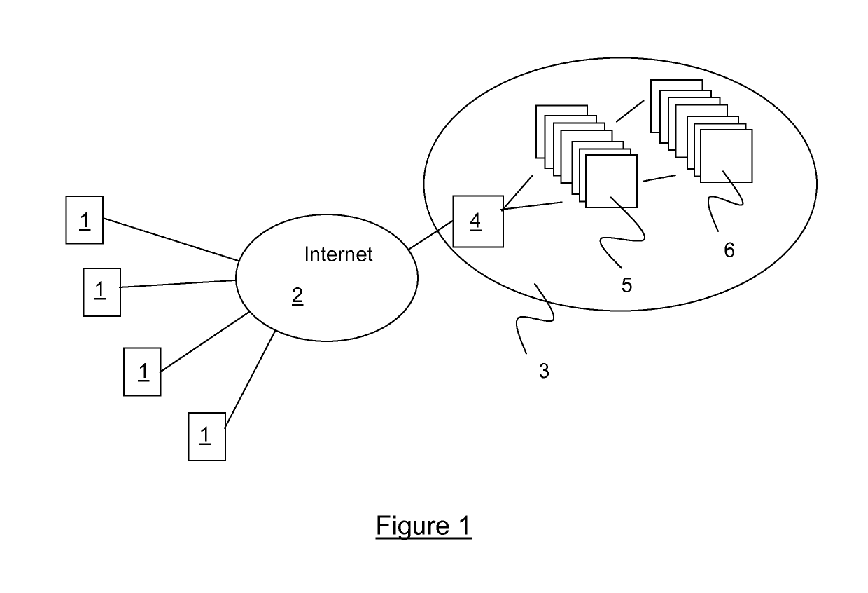

By way of example, FIG. 1 illustrates schematically a network architecture in which a multiplicity of client terminals 1, e.g. PCs, mobile phones, etc, are coupled to the Internet 2 via multiple access networks (not shown in the Figure). Also coupled to the Internet is a web-server cloud 3 that may be owned and operated by some service provider. Third party service providers can buy or rent computing capacity within the cloud. Here we consider the case of a barter service provider renting such capacity.

Within the cloud 3, a load sharing server 4 receives barter search queries from client terminals 1 and distributes these across a number of web servers 5. As well as being responsible for holding and distributing web content associated with the barter service, the web servers forward search queries to a number of database servers 6 (sometimes referred to as database engines). The database servers 6 maintain a copy or copies of a database containing all currently unresolved barter requests, i.e. each request comprising a user identity and an associated offer and wish. The offer and the wish together form a node pair. In particular, the offer and the wish of each such request represent a start node and a finish node for the user (depending upon the direction of the search, the offer may be the finish node and the wish may be the start node, as will be considered further below). As well as defining the have/want, each start/finish node has a unique identity within the database. Exactly how the database is structured is not relevant to the present discussion.

Consider now a user accessing a web page of the barter site via the cloud. The user enters into the web page displayed on his or her client terminal 1, an offer and a wish, representing respectively a start search node and a finish search node for the user (although again these definitions can be reversed). The user then clicks on a link to submit a query to the web cloud. This search query contains the start search node, i.e. the user's offer, and the finish search node, i.e. the user's wish. The search query is received by the load sharing server 4, and passed to one of the web servers 5 within the cloud. This web server cooperates with one or more of the database servers 6 to identify, within the database, those users who have as their finish node, i.e. wish, the start search node, i.e. offer, contained in the query. The web server then compares the start nodes of those users with the finish search node of the querying user, and flags any matches. It then returns to the querying user's client terminal a first level response containing the results, if any, of the database search. That is, the querying user receives all of the node pairs having as their finish node the start search node, as well as an identification of any matches, i.e. closed chains, amongst these.

Matches are displayed to the user as an immediate result in the web browser. [It will be appreciated that, in practice, the results will be sent to the client terminal as either a new web page, or as an instruction to update the currently presented web page with the results, together with supplementary data corresponding to the un-matched paths.] Meanwhile, for each non-matching result, the client terminal generates a second level search query, each containing the corresponding partial chain and the finish search node of the querying user, and sends this to the web-server cloud. The new start search node in each request is the last start node in the chain, that is the outstanding offer.

The load sharing server 4 receives these further queries, substantially simultaneously, and distributes them to the web servers. The web servers and database servers together process the queries in parallel. Again, for each query, a cloud server seeks to identify within the database, those users who have as their finish node, the new start search node contained in the query. The results are returned, as they are obtained, to the client terminal, with any matches being identified and flagged by the responsible web server. The cloud will typically return for each query the current path, from start search node (the offer of the requesting user) to the start node (that is the offer) of the most recently identified matching node pair.

The client terminal receives the set of second level responses and updates the displayed web page to include any further completed chains. The process is repeated again, with the client terminal sending further queries for each non-matching, second level result, and so on. The displayed list of results will likely continue to grow.

Either the user or the service may place some limit on the search strategy, for example, limiting the search to n-levels, i.e. so that the barter chains do not exceed n+1 users, or to some predefined number of results.

If at the end of the search process the querying user has, for whatever reason, not identified a suitable match, he or she may choose to add his query to the database so that it is available when other users subsequently perform searches. This may also happen for example if one of the other users in the barter chain declines to participate in the trade.

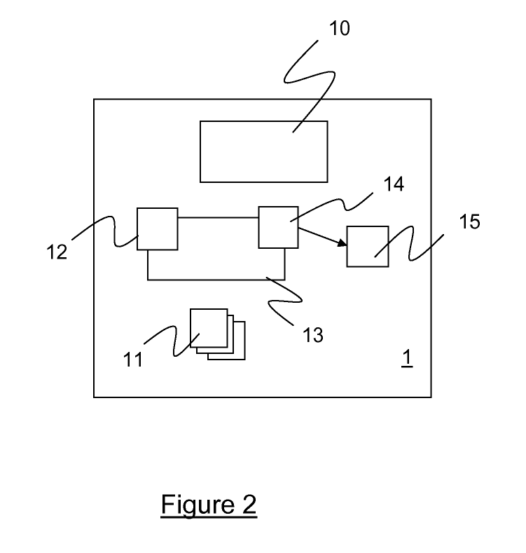

FIG. 2 illustrates schematically a user terminal 1 configured using appropriate software to participate in an online bartering service of the type considered above. The terminal comprises a display 10 and one or more user input devices 11 such as a keyboard, mouse etc. A software module 12 is run on processors 13 to implement a web browser, such as for example Internet Explorer™. When the user uses the browser to access the barter site, an executable component 14 is downloaded into the terminal and installed in the browser. This component may be Javascript™ code, an applet, flash component or the like. The component is responsible for accepting the user's offers and wishes via a browser window in the display 10, and for generating and sending an initial query to the web-server cloud. The component is also responsible for parsing the received results, for storing complete chains in a result memory 15 and displaying them in the browser window, and for generating second and further level queries, processing further responses etc. In practice, the result memory 15 may be a part of the display memory.

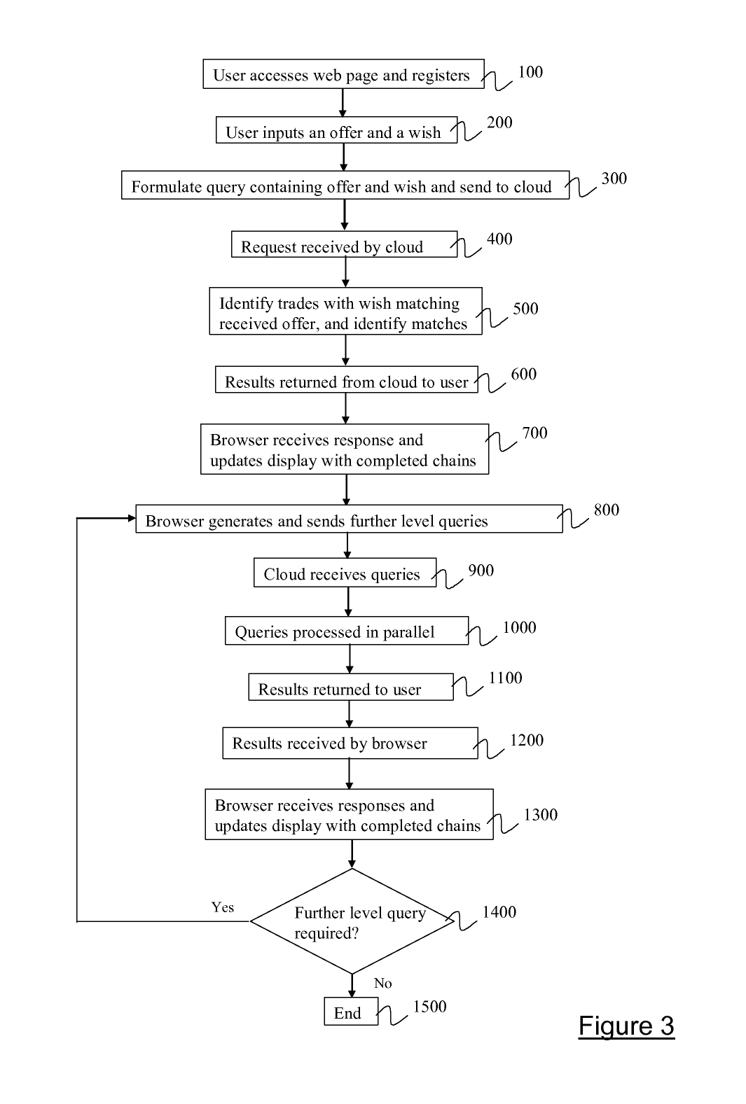

FIG. 3 is a flow diagram illustrating further the barter service described. The process begins at step 100 with a user accessing and registering to an online barter service. At step 200, via a displayed web page, the user selects or inputs both an offer an a wish. It will be understood that a user may enter data as a free form text, or may choose to select offers and wishes from available category and item type tree structures. At step 300, the browser (including executable component) formulates a search query containing the user's offer and wish, and sends this towards the barter service (server cloud). At step 400 the request is receiving within the cloud. The cloud then identifies at step 500 trades that include a wish matching the offer of the querying user. The cloud also identifies direct matches, i.e. closed chains. The results are returned to the querying user at step 600. At step 700 the browser receives the initial response and updates the displayed web browser page with the results, including any identified closed chains. Then, at step 800, the browser generates and sends further level queries, each including the offers of the unmatched trades. Again, the cloud receives the queries at step 900, and at step 1000 the queries are processed in parallel by the cloud servers. Responses are returned at step 1100 and received by the browser at step 1200. At step 1300, the receives the responses and again updates the browser window to show any further, closed chains. A check is then performed at step 1400 to determine if a further level query should be made. If not, the process ends at step 1500, otherwise the process flow returns to step 800.

Considering the matching problem at a more general level, it can be formulated as a simple algorithm for finding suitable paths comprising the following steps:
1. Define a criterion for determining that a path satisfies a goal. In the example of a bartering system referred to above for linking barters, a path is complete when the ring “closes”.
2. Start with an initial query to determine all nodes that can connect to a starting node. This results in a set 51 of paths (edges) from the starting node to the nodes that match the query.
3. Split 51 into a set of paths that are complete, referred to as R, and a set of paths that are not complete, referred to as E.
4. For each path in the set of incomplete paths E, send a further query to determine all nodes that can connect to the last node in the path. This results in a set Sn of paths (where n is the number of iterations) from the last node to the nodes that match the query, so that the path is extended by a number of branches. This results in the set of incomplete paths E being replaced by a larger set of paths each of which is one edge longer than the original path. It should be noted that, as this is done for each incomplete path, this step requires size(E) queries.
5. Add each complete path in the set Sn to R, and adopt the set of incomplete paths in the set Sn as a new value of E. In practice it may be useful to only add incomplete paths to E when the lengths of the paths are under a certain cut-off size, but this is not essential.
6. Unless E no longer includes any incomplete paths, go back to step 4.

Even if the client terminal issues tens or hundreds of queries (in practice most web browsers limit the number of outstanding queries to ten or less), the cloud will be able to respond to each of these queries vary rapidly. Accordingly the user agent receives all the resulting set Sn from the computing cloud almost simultaneously and can quickly go through steps 4 to 6 above. At the same time it is possible to present the (potentially growing) set R of complete paths to the user by way of actual results.

Such an algorithm provides the end user with the results of a potentially computationally expensive problem, very quickly. The benefit of the use of such an algorithm over a standard single/small cluster based approach is clear as effecting the same operation in a non-parallel environment would take much longer and prove an unacceptably frustrating experience for the user.

A further benefit of using a computing cloud are that the high peak load associated with a high number of queries in a search for paths, is distributed over a large number of server nodes. The high peak load occurs only infrequently so it would not be economically feasible to size a dedicated server cluster to cater for the high peak load case. Such a system is also more ecologically friendly as there is no need to run and cool a server cluster catering for a low average load whilst having capability for a high peak load. The user terminals also undertake part of the processing in that they maintain partial results and orchestrate the overall search process, and, since the processing is distributed over a large number of browsers, this lowers the actual CPU requirement on the server side. Moreover, it is not necessary for the cloud servers to maintain any state information in respect of an ongoing search. Queries associated with different search levels are in effect treated independently by the cloud.

The technique presented is especially of interest to problems where a priori computation of interesting paths is not possible or appropriate, where the number of path segments is very large with a high level of branching, and where it is beneficial to present at least some possible solutions as quickly as possible. Of course establishing barter chains is a good example, but there are many others.

In the case of a barter service, it may be advantageous to associate a “weight” with both complete, matching paths, and intermediate paths. This weight may for example represent a carbon dioxide (CO2) emission associated with the physical process of transferring the goods to be bartered along the chain. A low CO2 emission is obviously desirable in order to reduce the environmental impact of the transfer. Alternative weights may also be computed, for example revenue to the service provider. Regardless of the actual meaning of the weight, consider a function that is determined based on parameters in the end points. Let the function value be f_e for a specific trade (that is node pair). The target is to optimise, i.e. find the lowest (or highest) sum of the weight function for a specific ring or path F=SUM(f_e), where SUM(f_e) is calculated over all the node pairs in the ring/path. If the web-server cloud presents the weight function for a given trade in a response to a querying user, the client terminal/browser can perform the summing operation for each path as the path grows. As paths are completed, the weight can be displayed to the user as a property of that path.

The client terminal/browser may identify optimal paths from a weight point of view at each search level. It may then execute the next level search first for the most optimal paths, and then for other paths. Such an approach will likely produce good results quickly, although better solutions may still be identified at a later stage.

It will be appreciated by the person of skill in the art that various modifications may be made to the above described embodiments without departing from the scope of the present invention. For example, whilst according to the approach described above the search proceeds from a querying user's offer, until chains are completed to that user's wish, the chains may be formed in the reverse directions. That is, according to the above terminology, the start search node included in the initial query sent to the web-server cloud is the querying user's wish, and, for each trade held in the database, the start node is the associated user's wish and the finish node is that user's wish. In a further change to the described approach, the step of identifying closed chains may be performed at the client terminal rather than within the cloud. In this case, it may be unnecessary for a client terminal to include the finish search node (the wish in the example presented) in the requests sent to the cloud.

The skilled person will appreciate that it may be advantageous to provide even incomplete chains to an enquiring user. In this way, the user will see, in the context of a barter service, what he or she may obtain for his or her offer. The user may identify something of interest, even if this does not exactly satisfy his or her wish. Indeed, the search may be conducted without the user having to enter a wish. In this case, the server cloud will return to the client terminal's web browser, continually growing chains, until such time as the user or the service terminate the search.

1. A method of identifying within a database of node pairs, each comprising a start node and a finish node, one or more complete paths connecting a start search node to a finish search node, the method comprising:
a) sending a search query containing at least said start search node, from a client terminal to a network containing a multiplicity of servers each having access to said database;
b) receiving the search query at one of said servers, identifying node pairs having a finish node matching said start search node, and sending a response from the server to the client terminal identifying any matching node pairs;
c) receiving the response at the client terminal and storing those of any matching node pairs that have as a start node said finish search node;
d) in respect of each of one or more node pairs that have as a start node said finish search node, sending a further search query containing at least the corresponding start node to said network;
e) receiving the search queries within said network and distributing them across ones of the multiplicity of servers;
f) at each server receiving a further search query, identifying node pairs having a finish node matching the start node contained in the query, and sending a response from the server to the client terminal identifying any matching node pairs;
g) receiving the responses at the client terminal and storing those of any matching node pairs that have as a start node said finish search node; and
h) iteratively repeating steps d) to g) in respect of the further responses until some predefined criterion is met.

2. A method according to claim 1 and comprising, at steps a) and d), including in said search queries said finish search node and, at steps b) and f), identifying at the servers any of said matching node pairs that have a start node matching said finish search node and specifying these node pairs in said response.

3. A method according to claim 1 and comprising, at steps c) and g), following receipt of said responses at the user terminal, identifying at the client terminal any of said matching node pairs that have a start node matching said finish search node.

4. A method according to any claim 1, wherein steps a), c), d) and g) are implemented via a web browser running on the client terminal.

5. A method according to claim 4, wherein said responses sent from the servers to the client terminal are sent as web page data.

6. A method according to claim 5, wherein, at steps c) and g), the step of storing comprises causing the matching node pairs that have as a start node said finish search node to be displayed on the client terminal.

7. A method according to claim 1 and comprising, at step d), including in each said further search query the corresponding path including said start search node and the start and finish nodes of the already identified node pairs in the path.

8. A method according to claim 7 and comprising, at step f), including in each said response the corresponding path including said start search node and the start and finish nodes of the already identified node pairs in the path, including the node pair just identified.

9. A method according to claim 6 and comprising at step d), including in each said further search query the corresponding path including said start search node and the start and finish nodes of the already identified node pairs in the path, and comprising, at step f), including in each said response the corresponding path including said start search node and the start and finish nodes of the already identified node pairs in the path, including the node pair just identified, and the method further comprising causing the matching node pairs that have as a start node said finish search node to be displayed on the client terminal within the corresponding complete path.

10. A method according to claim 1, wherein said predefined criterion is one of a predefined number of iterations or a predefined number of complete paths.

11. A method according to claim 1, wherein, for each iteration stage, each of the further search queries are sent asynchronously, with a further search query being sent without waiting for a response to any earlier sent search query of the iteration stage.

12. A method according to claim 1, wherein said database is a database associated with an online trading service, and each said node pair is associated with a trading user, wherein,
for each node pair, the start node is one of an item/service possessed or wanted by the associated user and the finish node is the other of the item/service possessed or wanted, and
said start search node is one of an item/service possessed or wanted by a user of said client terminal and the finish search item is the other of an item/service possessed or wanted by that user.

13. A method of identifying complete paths, from a start search node to a finish search node, and extending across one or more node pairs each defined by a start node and a finish node, the method comprising:
a) sending a search query containing said start and finish search nodes from a client terminal to a network containing a multiplicity of servers each having access to said database;
b) receiving the query at one of said servers and identifying node pairs having a finish node matching said start search node, and, for each identified node pair, associating the node pair with said start search node to construct a search path, identifying any of said search paths that represent a complete path, and returning both complete and incomplete paths to the client terminal;
c) receiving complete and incomplete paths at the client terminal, storing any complete paths and, for each incomplete path, sending a further search query containing the incomplete search path and said finish search node to said network;
d) receiving the further search requests at servers of the network and, at each server receiving a query, identifying node pairs having a finish node matching the start node of the last node pair in the corresponding incomplete search path, and, for each identified node pair, associating the node pair with the incomplete path to form an extended search path;
e) at the receiving servers, identifying any of said extended search paths that represent a complete path, and returning both complete and incomplete paths to the client terminal;
f) repeating steps c) to e) in respect of the further responses until some predefined criterion is met.

14. A method of identifying within a database of node pairs, each comprising a start node and a finish node, one or more paths connecting a start search node to respective finish search nodes, the method comprising:
a) sending a search query containing at least said start search node, from a client terminal to a network containing a multiplicity of servers each having access to said database;
b) receiving the search query at one of said servers, identifying node pairs having a finish node matching said start search node, and sending a response from the server to the client terminal identifying any matching node pairs;
c) receiving the response at the client terminal and storing at least the start node of each matching node pair;
d) in respect of each of the matching node pairs, sending a further search query containing at least the corresponding start node to said network;
e) receiving the search queries within said network and distributing them across ones of the multiplicity of servers;
f) at each server receiving a further search query, identifying node pairs having a finish node matching the start node contained in the query, and sending a response from the server to the client terminal identifying any matching node pairs;
g) receiving the responses at the client terminal and storing at least the start node of each matching node pair; and
h) iteratively repeating steps d) to g) in respect of the further responses until some predefined criterion is met.

15. A method according to claim 1 and comprising, for each matching node pair identified at a server, also determining a weight associated with a link connecting that node pair to the preceding node in the path, and determining a sum of the weights of all node pairs in the path, and storing that at the client terminal.

16. A method according to claim 15, wherein a weight is indicative of an amount of carbon dioxide that would be generated by a business transaction involving the associated node pairs.

17. A method according to claim 15 and comprising prioritising the sending of further search queries, from the client terminal, in dependence upon the summed weights.

18. A method according to claim 15 and comprising displaying the stored node pairs or links on a display of the client terminal, the stored node pairs or links being displayed in weight order.

19. A computer readable memory storing a program configured to be run in association with a web browser on a computer to cause the computer to:
1) parse web data, received in response to a search request sent from the computer to the Internet, so as to identify incomplete results in the web data;
2) send to the Internet, for each identified incomplete result, a further search request, these requests being sent asynchronously; and
3) to repeat steps 1) and 2) for each further response.

20. A method according to claim 13 and comprising, for each matching node pair identified at a server, also determining a weight associated with a link connecting that node pair to the preceding node in the path, and determining a sum of the weights of all node pairs in the path, and storing that at the client terminal.

21. A method according to claim 20, wherein a weight is indicative of an amount of carbon dioxide that would be generated by a business transaction involving the associated node pairs.

22. A method according to claim 20 and comprising prioritising the sending of further search queries, from the client terminal, in dependence upon the summed weights.

23. A method according to claim 20 and comprising displaying the stored node pairs or links on a display of the client terminal, the stored node pairs or links being displayed in weight order.

24. A method according to claim 14 and comprising, for each matching node pair identified at a server, also determining a weight associated with a link connecting that node pair to the preceding node in the path, and determining a sum of the weights of all node pairs in the path, and storing that at the client terminal.

25. A method according to claim 24, wherein a weight is indicative of an amount of carbon dioxide that would be generated by a business transaction involving the associated node pairs.

26. A method according to claim 24 and comprising prioritising the sending of further search queries, from the client terminal, in dependence upon the summed weights.

27. A method according to claim 24 and comprising displaying the stored node pairs or links on a display of the client terminal, the stored node pairs or links being displayed in weight order.
